(19) United States
(12) Patent Application Publication
(10) Pub. No.: US 2024/0368498 A1
(43) Pub. Date: Nov. 7, 2024

(54) METHODS FOR CONCENTRATING FATTY ACIDS AND FATTY ACID ESTERS

(71) Applicant: UNIVERSITY OF IOWA RESEARCH FOUNDATION, Iowa City, IA (US)

(72) Inventors: Ned B. Bowden, Iowa City, IA (US); Nimesh Pasan Ranasin Ranasinghe Arachchige, Iowa City, IA (US)

(73) Assignee: UNIVERSITY OF IOWA RESEARCH FOUNDATION, Iowa City, IA (US)

(21) Appl. No.: 18/652,556

(22) Filed: May 1, 2024

Related U.S. Application Data
(60) Provisional application No. 63/463,500, filed on May 2, 2023.

(51) Int. Cl. C11C 1/00

(52) U.S. Cl. CPC C11C 1/005; C11C 1/007

(57) ABSTRACT

The invention provides methods that can be used to separate mixtures of fatty acids and fatty acid esters into individual components or into more concentrated mixtures of individual components.

### CROSS-REFERENCE TO RELATED APPLICATIONS

This application claims priority from U.S. Provisional Patent Application No. 63/463,500, filed 2 May 2023. The entire content of U.S. Provisional Patent Application No. 63/463,500 is hereby incorporated herein by reference.

### STATEMENT REGARDING FEDERALLY SPONSORED RESEARCH

This invention was made with government support under NSF-PFI-1827336 awarded by The National Science Foundation. The government has certain rights in the invention.

### BACKGROUND OF THE INVENTION

Membrane separation has experienced rapid growth in the past few decades (S. Yuan, et al., Chem. Soc. Rev., 2019, 48, 2665). A variety of membranes with pore size ranging from several micrometers to sub-nanometers have been fabricated from conventional amorphous polymers such as polyimide (PI), polyamide (PA), polyacrylonitrile (PAN), polyether sulfone (PES), polysulfone (PSF), polyvinylidene fluoride (PVDF), and poly(amide-imide)-based crosslinked polymers, etc. (S. Karan, et al., Science, 2015, 348, 1347-1351). However, these polymers are not optimal, because the resulting membranes lack ordered and tunable pore channels leading to a typical non-uniform pore size, limited porosity, and poor interconnectivity.

Covalent organic frameworks (COFs) are a class of crystalline porous materials comprising of periodically extended and covalently bound crystalline porous network structures. (A. P. Cote, et al., Science, 2005, 310, 1166-1170; and Z. Wang, et al., Chem. Soc. Rev., 2020, 48, 708). COFs have the advantage of a low density, large surface area, tunable pore size and structure, tailored functionality, and versatile covalent-combination of building units, attracting increasing interests from the fields of gas storage and separation, adsorption, catalysis, sensing, electroactive materials, and energy storage (M. S. Lohse and T. Bein, Adv. Funct. Mater., 2018, 28, 1705553)

COFs are typically synthesized from organic linkers via reversible covalent bond formation. The regular and periodical assembly of these organic linkers by covalent bonds endows COFs with orderly arranged pores, a uniform pore size and a high pore density. These characteristics make COFs promising candidates for constructing advanced separation membranes. Moreover, the functionalities of COF membrane can be tuned through the introduction of various functional sites on the organic linkers to allow a high degree of control over host-guest interactions in an attractive or repulsive way.

Over 140 million tons of vegetable oils are produced in the United States each year; this value has been increasing by 5% a year since 2000. The quantity of oils is expected to greatly increase if biodiesels from algae are produced in significant quantities as some believe will happen (Clemente, T. E.; Cahoon, E. B. Plant Physiology 2009, 151, 1030; Harris, W. S. J. Nutr. 2012, 142, 600S; Lecerf, J.-M. Soy and Health 2000: Clinical Evidence, Dietetic; Applications; Garant Publishers: Brussels, Belgium, 2001; p 93; Pryde, E. H. Am. Soybean Assoc. 1980, 13; Van, G. J.; Knothe, G. AOCS Monogr. Ser. Oilseeds 2008, 2, 499; Warner, K. A. AOCS Monogr. Ser. Oilseeds 2008, 2, 483; and Winkle, M.; Poole, S. Cereal Foods World 2002, 47, 378). Vegetable oils are triesters of glycerol (HOCH₂CHOHCH₂OH) and three fatty acids; each fatty acid contains 16, 18, 20, or 22 carbon atoms and zero, one, or more carbon-carbon double bonds depending on their source (Baer, D. J. Am. J. Clin. Nutr. 2012, 95, 267; Cascio, G, et al., Curr. Diabetes Rev. 2012, 8, 2; Dhaka, V., et al., J. Food Sci. Technol. 2011, 48, 534; Flock, M. R., et al., Curr. Atheroscler. Rep. 2011, 13, 499; and Gebauer, S. K., et al., J. Adv. Nutr. 2011, 2, 332). For example, over 35 million tons of soybean oil are produced each year, and it has a composition of 10% palmitic acid, 4% stearic acid, 18% oleic acid, 55% linoleic acid, and 13% linolenic acid.

Despite the large-scale production of vegetable oils and the fact that they are a critical biorenewable source of starting materials, both the oils and their fatty acids are used only in small quantities in industrial applications. Over 96% of vegetable oils are “burned” by humans or animals after being consumed or in engines when used as biodiesel. A critical reason for the lack of applications of fatty acids as a starting material for industrial applications is that it is not possible to separate a mixture of fatty acids into individual components on a scale of millions of tons per year. Fatty acids isolated from vegetable oils are a mixture of five or more different fatty acids with different reactivities that will yield different products after a reaction. Simply, when a mixture of five fatty acids derived from soybean oil are used as starting materials in an industrial process, many different products are obtained. The challenge of utilizing a mixture of fatty acids as starting materials limits their broader transformations into more valuable commercial products.

A. Gupta and N. Bowden, ACS Appl. Mater. Interfaces 2013, 5, 924-933 reported the separation of cis-fatty acids from trans-fatty acids using nanoporous polycyclopentadiene membranes. In this study amines were required to be added to coordinate to the fatty acids to form salts; separation of fatty acids without amines present was poor. The addition of amines required their removal after separation which would increase the number of steps in the isolation of enriched fatty acids. In addition, the separations were by osmosis and required days to complete and large amounts of solvent. Furthermore, the polydicyclopentadiene is highly unsaturated and prone to oxidation which limits its lifetime as a membrane. Finally, this method could not be used to separate mixtures of fatty acid esters.

Currently, there is a need for methods that can be used to separate mixtures of fatty acids and fatty acid esters into individual components or into more concentrated mixtures of individual components.

### SUMMARY OF THE INVENTION

The invention provides methods that can be used to separate mixtures of fatty acids and fatty acid esters into individual components or into more concentrated mixtures of individual components.

In one embodiment, the invention provides a method comprising:
providing a starting liquid that comprises two or more compounds selected from the group consisting of fatty acids and fatty acid esters, wherein each compound is present in a starting mole ratio with respect to each other compound;
passing the liquid through a membrane that comprises covalent organic frameworks to provide a filtered liquid; and
collecting a fraction of the filtered liquid wherein at least one mole ratio for one compound has changed when compared to the starting liquid.

In another embodiment, the invention provides, a method for concentrating a fatty acid or a fatty acid ester from a starting liquid, comprising:
providing a starting liquid that comprises two or more compounds selected from the group consisting of fatty acids and fatty acid esters;
passing the starting liquid through a membrane that comprises covalent organic frameworks; and
collecting a fraction of the liquid that has passed through the membrane, wherein at least one of the fatty acids or fatty acid esters is more concentrated in the fraction compared to the starting liquid.

In another embodiment, the invention provides a method for concentrating a fatty acid from a starting liquid, comprising:
providing a starting liquid that comprises two or more fatty acids;
passing the starting liquid through a membrane that comprises covalent organic frameworks; and
collecting a fraction of the liquid that has passed through the membrane, wherein at least one fatty acid is more concentrated in the fraction compared to the starting liquid.

In another embodiment, the invention provides a method for concentrating a fatty acid ester from a starting liquid, comprising:
providing a starting liquid that comprises two or more fatty acid esters;
passing the starting liquid through a membrane that comprises covalent organic frameworks; and
collecting a fraction of the liquid that has passed through the membrane, wherein at least one fatty acid ester is more concentrated in the fraction compared to the starting liquid.

In another embodiment, the invention provides a method for isolating a target fatty acid or a target fatty acid ester from a starting liquid, comprising:
providing a starting liquid that comprises the target fatty acid or the target fatty acid ester and at least one or more compound selected from the group consisting of fatty acids and fatty acid esters;
passing the starting liquid through a membrane that comprises covalent organic frameworks; and
collecting a fraction of the liquid that has passed through the membrane, wherein the mole ratio between the target fatty acid or the target fatty acid ester and the compound in the fraction differs from the mole ratio between the target fatty acid or the target fatty acid ester and the compound in the starting liquid.

In another embodiment, the invention provides a method for preparing an enriched sample of a fatty acid or a fatty acid ester from a starting liquid that comprises two or more compounds selected from the group consisting of fatty acids and fatty acid esters, comprising: passing all or part of the starting liquid through a membrane that comprises covalent organic frameworks to provide the enriched sample of the fatty acid or the fatty acid ester. In one embodiment, the enriched sample of the fatty acid or the fatty acid ester is collected from starting liquid that passed through the membrane. In one embodiment, the enriched sample of the fatty acid or the fatty acid ester remains in starting liquid that has not passed through the membrane.

The invention provides a method for increasing the purity of a fatty acid or a fatty acid ester, from a starting mixture that comprises the fatty acid or the fatty acid ester and at least one other fatty acid or a fatty acid ester. The fatty acid or the fatty acid ester is obtained in higher purity by passing the starting liquid through a membrane that comprises covalent organic frameworks, which allow the fatty acid or the fatty acid ester and the at least one other fatty acid or a fatty acid ester to pass through the membrane at different rates, so that the fatty acid or the fatty acid ester is obtained in higher purity on one side of the membrane. Accordingly, in another embodiment, the invention provides a method for increasing the purity of a fatty acid or a fatty acid ester, from a starting mixture that comprises the fatty acid or the fatty acid ester and at least one other fatty acid or at least one other fatty acid ester, comprising passing the starting liquid through a membrane that comprises covalent organic frameworks, under conditions that allow the fatty acid or the fatty acid ester and the at least one other fatty acid or the at least one other fatty acid ester to pass through the membrane at different rates, so that the purity of the fatty acid or the fatty acid ester is increased on one side of the membrane.

### BRIEF DESCRIPTION OF DRAWINGS

FIGS. 1a-1c: a) COFs were synthesized by reaction of diamines with Tp to yield COFs with hexagonal pores. b) Amines employed in the synthesis of the COFs and the corresponding size of the pores are shown. c) The different structures of COFs and their pore apertures are shown.

FIG. 2: Shows an illustration of an apparatus at a starting time and the apparatus at a time after the starting time. A membrane was place between two glass arms. At the start of a separation, solvent was added to both sides of the membrane with C18 FMAEs only added to the retentate side. Chemicals with fast flux permeated the membrane rapidly while chemicals with slower flux permeated at a slower rate.

FIG. 3: Illustrates the separation of fatty acid esters according to a method of the invention.

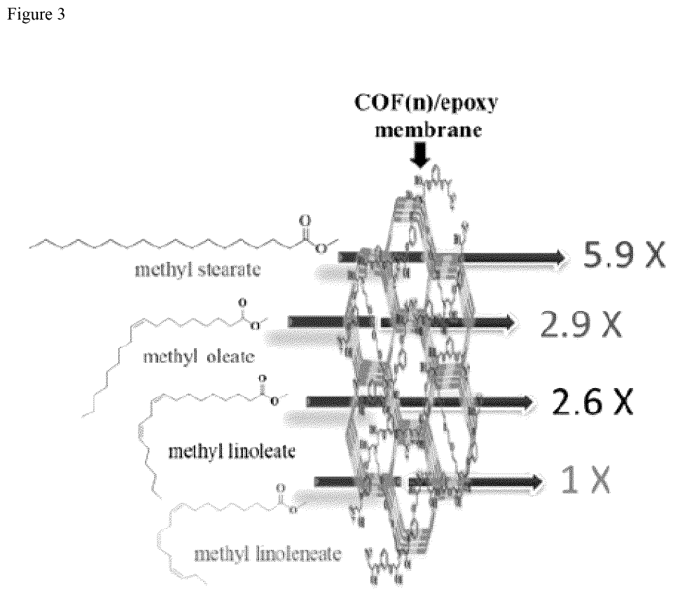

FIG. 4: shows a) The structure of the small fragment (S1) is shown; and b) The structures of methyl (Z)-5-octenoate and ethyl octanoate are shown.

### DETAILED DESCRIPTION OF THE INVENTION

In one embodiment, the starting liquid comprises two or more fatty acids.

In one embodiment, the starting liquid comprises three or more fatty acids.

As used herein, the term “fatty acid” includes branched and unbranched carboxylic acids having 8-30 carbons and zero, one, or more double bonds (e.g., 0, 1, 2, 3, or 4 double bonds). In one embodiment, the fatty acid comprises 8-16 carbon atoms. In one embodiment, the fatty acid comprises 16-30 carbon atoms. In one embodiment, the fatty acid comprises 16-24 carbon atoms. In one embodiment, the fatty acid comprises 16-20 carbon atoms. In one embodiment, the fatty acid comprises one or more cis-double bonds. In one embodiment, the fatty acid comprises one or more trans-double bonds. In one embodiment, the fatty acid is palmitic acid, stearic acid, oleic acid, linoleic acid, or linolenic acid.

As used herein, the term “fatty acid ester” includes esters of fatty acids. In one embodiment, the fatty acid ester is a (C₁-C₄)alkyl ester of a fatty acid. In one embodiment, the fatty acid ester is a methyl, ethyl, propyl, isopropyl, butyl, or tert-butyl ester ester of a fatty acid, for example, methyl palmate, methyl stearate, methyl oleate, methyl linolate, methyl linolenate, ethyl palmate, ethyl stearate, ethyl oleate, ethyl linolate, ethyl eicosapentaenoic acid, docosahexaenoic acid ethyl ester, or ethyl linolenate. In one embodiment, the fatty acid ester comprises a total of 9-34 carbon atoms. In one embodiment, the fatty acid ester comprises a total of 9-20 carbon atoms. In one embodiment, the fatty acid ester comprises a total of 17-34 carbon atoms. In one embodiment, the fatty acid ester comprises a total of 17-28 carbon atoms. In one embodiment, the fatty acid ester comprises a total of 17-24 carbon atoms.

According to the methods of the invention, the starting liquid can be passed through the membrane at any suitable temperature. In one embodiment, the starting liquid is at a temperature above about 0° C. In one embodiment, the starting liquid is at its boiling point. In one embodiment, the starting liquid is at a temperature in the range of about 0° C. to about 100° C. In one embodiment, the starting liquid is at a temperature in the range of about 0° C. to about 25° C. In one embodiment, the starting liquid is at a temperature in the range of about 25° C. to about 100° C. In one embodiment, the starting liquid is at a temperature in the range of about 25° C. to about 50° C.

According to the methods of the invention, the starting liquid can be a neat mixture of fatty acids and/or fatty acid esters, or the starting liquid may comprise a solvent. In one embodiment, the solvent is selected form the group consisting of (C₁-C₄)alkanols, hexanes, and methylene chloride. In one embodiment, the solvent is selected form the group consisting of methanol, ethanol, propanol, isopropanol, butanol, tert-butanol, hexanes, and methylene chloride.

According to the methods of the invention, the starting liquid can comprise fatty acids and/or fatty acid esters that are derived from any source. In one embodiment, the starting liquid comprises a fish oil or a seed oil. In one embodiment, the starting liquid comprises corn oil, soybean oil, palm oil, or linseed oil.

In one embodiment, the starting liquid comprises soybean oil.

According to the methods of the invention, the membrane can comprise covalent organic frameworks and at least one polymer. Suitable polymers include, for example, epoxy, polyimides, polyamides, polyether ether ketone, polyesters, polybutadiene, polyisoprene, and random or block polymers.

In one embodiment, the Covalent Organic Frameworks represent about 5% to about 99% of the membrane by weight. In one embodiment, the Covalent Organic Frameworks represent about 5% to about 70% of the membrane by weight. In one embodiment, the Covalent Organic Frameworks represent about 5% to about 50% of the membrane by weight. In one embodiment, the Covalent Organic Frameworks represent about 5% to about 30% of the membrane by weight. In one embodiment, the Covalent Organic Frameworks represent about 5% to about 20% of the membrane by weight.

In one embodiment, the Covalent Organic Frameworks represent about 1% to about 99% of the membrane by weight. In one embodiment, the Covalent Organic Frameworks represent about 10% to about 70% of the membrane by weight. In one embodiment, the Covalent Organic Frameworks represent about 10% to about 50% of the membrane by weight. In one embodiment, the Covalent Organic Frameworks represent about 10% to about 30% of the membrane by weight.

In one embodiment, the Covalent Organic Frameworks represent about 10% to about 20% of the membrane by weight.

In one embodiment, the membrane comprises covalent organic frameworks and does not comprise another polymer.

In one embodiment, a method comprising: providing a starting liquid comprising a plurality of compounds selected from a group consisting of fatty acids and fatty acid esters, wherein each of the plurality of compounds is present in a starting liquid mole ratio with respect to each the plurality of compounds; and passing the starting liquid through a membrane comprising a covalent organic framework to provide a filtered liquid including the plurality of compounds, the filtered liquid having a filtered mole ratio between each of the plurality of compounds, the filtered mole ratio between at least two of the plurality of compounds in the filtered liquid being changed from the starting liquid mole ratio between the at least two of the plurality of compounds is provided.

In some embodiments, a method includes providing a starting liquid comprising a plurality of compounds selected from a group consisting of fatty acids and fatty acid esters, wherein each of the plurality of compounds is present in a starting liquid mole ratio with respect to each the plurality of compounds; and passing the starting liquid through a membrane comprising a covalent organic framework to provide a filtered liquid including the plurality of compounds, the filtered liquid having a filtered mole ratio between each of the plurality of compounds, the filtered mole ratio between at least two of the plurality of compounds in the filtered liquid being changed from the starting liquid mole ratio between the at least two of the plurality of compounds.

In one embodiment, a method for increasing purity of a starting liquid including a fatty acid or a fatty acid ester, the starting liquid including at least one other fatty acid or at least one other fatty acid ester, the method comprising: passing the starting liquid through a membrane comprising a covalent organic framework under conditions that allow the fatty acid or the fatty acid ester and the at least one other fatty acid or the at least one other fatty acid ester to pass through the membrane at different rates, so that the purity of the fatty acid or the fatty acid ester is increased on one side of the membrane is provided.

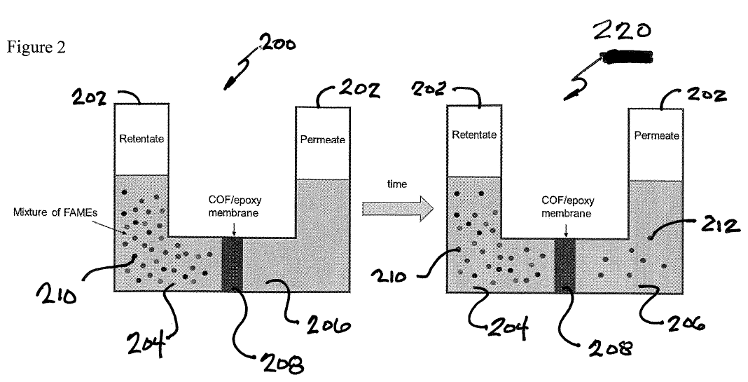

FIG. 2 shows an illustration of an apparatus 200 at a starting time and the apparatus 220 at a time after the starting time. The apparatus 200 and the apparatus 220 include a reservoir 202 having a first reservoir section 204 and a second reservoir section 206. A membrane 208 separates the first reservoir section 204 from the second reservoir section 206. In some embodiments, the membrane 208 includes a covalent organic framework to provide a filtered liquid flowing through the membrane 208 from the first reservoir section 204 to the second reservoir section 206. In operation, the first reservoir section 204 includes a plurality of compounds 210 that are filtered by the membrane and flow into the second reservoir section 206 and become a filtered plurality of compounds 212.

As used herein, the term “Covalent Organic Framework” includes boroxine-linked, boronate ester-linked, imine-linked, hydrazone-linked, azine-linked, β-ketoenamine-linked, triazine-linked, imide-linked, phenazine-linked, and sp2-carbon linked Covalent Organic Frameworks (Z. Wang, et al., Chem. Soc. Rev., 2020, 48, 708). In one embodiment, the Covalent Organic Framework is a β-ketoenamine-linked Covalent Organic Framework. In one embodiment, the Covalent Organic Framework is derivable from 1,3,5-triformylphloroglucinol (Tp). In one embodiment, the Covalent Organic Framework is derivable from 1,3,5-triformylphloroglucinol and a diamine. In one embodiment, the Covalent Organic Framework is derivable from 1,3,5-triformylphloroglucinol and a diamine selected from the group consisting of hydrazine, p-phenylenediamine, benzidine, and 4,4′-(buta-1,3-diyne-1,4-diyl)dianiline. In one embodiment, the Covalent Organic Frameworks have average pore sizes in the range of from about 1 nanometer to 10 nanometers. In one embodiment, the Covalent Organic Frameworks have average pore sizes in the range of from about 1 nanometer to 8 nanometers. In one embodiment, the Covalent Organic Frameworks have average pore sizes in the range of from about 1 nanometer to 6 nanometers. In one embodiment, the Covalent Organic Frameworks have average pore sizes in the range of from about 1 nanometer to 5 nanometers. In one embodiment, the Covalent Organic Frameworks have average pore sizes in the range of from about 1 nanometer to 4 nanometers. In one embodiment, the Covalent Organic Frameworks have average pore sizes in the range of from about 2 nanometer to 10 nanometers. In one embodiment, the Covalent Organic Frameworks have average pore sizes in the range of from about 2 nanometer to 8 nanometers. In one embodiment, the Covalent Organic Frameworks have average pore sizes in the range of from about 2 nanometer to 6 nanometers. In one embodiment, the Covalent Organic Frameworks have average pore sizes in the range of from about 2 nanometer to 5 nanometers. In one embodiment, the Covalent Organic Frameworks have average pore sizes in the range of from about 2 nanometer to 4 nanometers. In one embodiment, the Covalent Organic Frameworks have average pore sizes of about 1 nanometer. In one embodiment, the Covalent Organic Frameworks have average pore sizes of about 2 nanometers. In one embodiment, the Covalent Organic Frameworks have average pore sizes of about 3 nanometers. In one embodiment, the Covalent Organic Frameworks have average pore sizes of about 4 nanometer.

As used herein, the term “about” means ±10%.

As used herein, the term “flux” means the flow rate of the mixtures of fatty acids or fatty acid esters per unit area of the membrane. Flux can be defined in terms of (moles/hour cm²) or liters/meter² hour. In one embodiment, the membrane has a flux of at least 0.005 liters/meter² hour. In another embodiment, the membrane has a flux of at least 0.05 liters/meter² hour.

In one embodiment, the membrane that comprises covalent organic frameworks is coated onto a backing. In one embodiment, the backing is a nanofiltration membrane. In one embodiment, the backing comprises polydicyclopentadiene, polyimide, polyaniline, or polyacrylate. In one embodiment, the backing comprises poly(acrylonitrile). In one embodiment, the membrane is part of a spiral wound module.

The invention will now be illustrated by the following non-limiting Examples.

### EXAMPLES

### Example 1

### Experimental

Materials and methods. All chemicals were purchased from Acros, Sigma Aldrich, Alpha Aesar, BDH, or TCI. PZ flat sheet membranes composed of poly(acrylonitrile) (molecular weight cutoff of 30,000 g mol⁻¹) were purchased from Synder Filtration and used as received. ¹H NMR spectra were collected at room temperature using a Bruker DRX-400 at 400 MHz and a Bruker DPX500 at 500 MHz. NMR samples were referenced to TMS. Powder X-ray diffraction (PXRD) spectra were obtained using a Siemens Model D5000 X-ray diffractometer (Bruker AXS Inc.) in reflection mode using CuKα X-rays radiations (λ=1.54 Å). The 20 range from 2° to 35° was scanned with a scan rate of 1° min⁻¹. The wide-angle X-ray diffraction (WXRD) analysis of the COF(n)/epoxy membranes used the USAXS instrument at Advanced Photon Source, Argonne National Laboratory. The X-ray energy was 21 keV (λ=0.5895 Å). Scanning electron microscopy (SEM) was performed on an S-2700 scanning electron microscopy (Hitachi, Japan). The particles were placed on an aluminum specimen stub using adhesive carbon tape. The mount was then coated by ion sputtering with conductive gold set at 10 mA for 2.5 minutes and examined using SEM operated at a 2 kV accelerating voltage. Fourier transform infrared (FT-IR) spectra were collected at room temperature using Avatar 370 FT-IR with a Diamond ATR (attenuated total reflection) in the 700-4000 cm⁻¹ region.

Synthesis of 1,3,5-triformylphloroglucinol (Tp). A mixture of hexamethylenetetramine (15.1 g, 107.9 mmol), phloroglucinol (6.0 g, 47.6 mmol), and trifluoroacetic acid (90 mL) was placed in a dry 500 mL round bottom flask and heated at 100° C. for 2.5 h under N₂. Then 150 mL of 3 M HCl was added, and the solution was heated at 100° C. for another 1 hour. The reaction mixture was allowed to cool to room temperature, the insoluble residues were removed by filtration, and the filtrate was extracted with dichloromethane (3×100 mL). The organic phases were combined and dried over anhydrous Na₂SO₄. The desired product was obtained after removing the solvent under reduced pressure, followed by recrystallization of the crude product in ethanol, yielding a yellow powder (2.2 g, 20% yield). ¹H NMR (500 MHz, CDCl₃) δ=10.15 (s, CHO), 14.13 (s, OH). ¹³C NMR (75 MHz, CDCl₃) δ=192.07, 173.58, and 102.87.

Synthesis of HCOF. A Pyrex ampule (50 mL) was charged with Tp (42.0 mg, 0.2 mmol), anhydrase hydrazine (0.02 mL, 0.3 mmol), 13.6 mL of 1,4-dioxane, 1.2 mL of mesitylene, and 4.6 mL of 6 M acetic acid. The mixture was sonicated for 10 minutes at room temperature for a homogeneous dispersion. The tube was then flash frozen at 77 K (liquid N₂ bath) and degassed by three freeze-pump-thaw cycles. The tube was sealed off and then heated at 120° C. for 3 days. A dark red precipitate was collected by filtration and washed with methanol, dimethylformamide, and THF. The resulting powder was then immersed in anhydrous THF for 3 days. It was filtered and dried under vacuum for 24 hours at room temperature to yield a dark red solid (82% isolated yield).

Synthesis of TpPa, TpBD, and TpBDDA COFs. A pyrex ampule (25 mL) was charged with Tp (63 mg, 0.3 mmol), corresponding diamine [p-phenylenediamine (Pa) [48.0 mg, 0.45 mmol]; benzidine (BD) 183.0 mg, 0.45 mmol]; 4,4′-(buta-1,3-diyne-1,4-diyl) dianiline (BDDA) [105.0 mg, 0.45 mmol], 1.5 mL of 1,4-dioxane, 1.5 mL of mesitylene and 0.5 mL of 6 M acetic acid. The mixture was sonicated for 10 minutes at room temperature for a homogeneous dispersion. The tube was degassed by three freeze-pump-thaw cycles. The tube was sealed off and then heated at 120° C. for 3 days for TpPA and TpBD. The vial was heated to 120° C. for 4 days for the synthesis of TpBDDA. A colored [TpPA (dark red), TpBD (yellow), TpBDDA (orange)] precipitate was collected by filtration and washed with anhydrous acetone. The powder collected was then solvent exchanged with anhydrous acetone 5-6 times and then dried at 180° C. under vacuum for 24 hours to yield the corresponding COFs in high yields [TpPA (80%), TpBD (82%) and TpBDDA (84%)].

Synthesis of COF fragment (S1). In a 100 mL round bottom flask, Tp (100 mg, 0.48 mmol) and aniline (443 mg, 4.8 mmol) were dissolved in ethanol (30 mL). The reaction was refluxed overnight and then cooled to room temperature.⁵¹ The yellow precipitate was collected by filtration, washed with cold ethanol, and dried under the reduced pressure to afford the product as a yellow solid (165 mg, 0.39 mmol, 80% yield). ¹H NMR (500 MHz, CDCl₃) δ=13.0-13.4 (m, NH, 3H), 8.94-8.69 (m, HC—N, 3H), 7.43 (m, Ph, 6H), 7.32 (m, Ph, 6H), 7.22 (m, Ph, 3H). ¹³C NMR (75 MHz, CDCl₃): δ 185.53, 149.31, 139.05, 129.90, 125.67, 117.68, 106.69.

Synthesis of epoxy membrane. Amine (4,7,10-trioxa-1,13tridecanediamine, 1.97 mL, 0.009 mol), epoxide (resorcinol diglycidyl ether, 4.0 g, 0.018 mol), and dimethylformamide (0.64 mL) were combined in a scintillation vial and mixed thoroughly using a Vortex-Genie2 and Teflon stir bar. Slight vacuum was pulled on the vial to remove air bubbles created by mixing. A sample of the mixture (1.5 mL) was spread on top of a 12.5 cm×12.5 cm square of PZ flat sheet membrane. A small beaker of dimethylformamide (DMF, 10 mL) was placed next to the membrane. A glass cover was placed over top of the membrane and the small beaker of DMF. The polymer was cured at room temperature for 72 hours.

Preparation of COF(n)/epoxy hybrid membranes. The [COF(n)/epoxy] membranes where n=10 or 20 on w/w basis were prepared by the solution casting method. The amine (4,7,10-trioxa-1,13-tridecanediamine, 1.97 mL, 0.009 mol), epoxide (resorcinol diglycidyl ether, 4.0 g, 0.018 mol), and dimethylformamide (2.0 mL) were combined in a scintillation vial and mixed thoroughly using a Vortex-Genie2 and Teflon stir bar. Slight vacuum was pulled on the vial to remove air bubbles created by mixing. Next, the epoxy monomers in DMF were mixed with the HCOF, TpPA, TpBD or TpBDDA (1.50 g or 0.67 g) and stirred for 15 minutes followed by bath sonication for 30 minutes to obtained homogenous suspensions. The suspensions were poured on the PZ membrane on a spin coater and spun at 2000 rpm for 3 minutes. A small beaker of DMF (10 mL) was placed next to the membrane. A glass cover was placed over the membrane and the beaker of DMF. The membranes were cured at room temperature for 72 hours.

Measurement of flux of FAMEs and FAs using ¹H NMR spectroscopy. In these separations the flux of the FAMEs and FAs were quantified using ¹H NMR spectroscopy. In each separation, methyl stearate (or stearic acid) was used with one of the unsaturated FAMEs (or FAs). This allowed the flux of both chemicals to be found using unique peaks in the NMR spectra.

Separation of methyl stearate and methyl oleate through HCOF(n)/epoxy, TpPa(n)/epoxy, TpBD(n)/epoxy, and TpBDDA(n)/epoxy membranes. A TpPA(20)/epoxy membrane was clamped between two glass vessels. Methyl stearate (1.07 g, 3.60 mmol), methyl oleate (1.2 mL, 3.60 mmol), and p-nitrobenzaldehyde (0.54 g, 3.60 mmol) were added with 30 mL of dichloromethane (DCM) to the one side (retentate) of the membrane. DCM (30 mL) was added to other side (permeate) of the membrane. To both the sides of the membrane, a small amount of butylhydroxytoluene (BHT) was added as an antioxidant. Solvent on both sides of the membrane was stirred continuously at room temperature. At 12, 24, 36, 48, 60, 84, and 108 hours, a 1 mL aliquot of solvent was removed from both sides of the membrane. Triphenylmethane (0.5 mL of a 0.25M stock solution) was added to each aliquot and the solvent was removed under vacuum. The aliquots were analyzed by ¹H NMR spectroscopy to determine the concentrations of FAMEs and p-nitrobenzaldehyde. Each separation was repeated three times. The same procedure was followed for all the membranes.

Separation of methyl stearate and methyl linoleate through HCOF(n)/epoxy, TpPa(n)/epoxy, TpBD(n)/epoxy, and TpBDDA(n)/epoxy membranes in DCM as the solvent. A TpPA(20)/epoxy membranes were clamped between two glass vessels. Methyl stearate (1.07 g, 3.60 mmol), methyl linoleate (1.2 mL, 3.62 mmol), and p-nitrobenzaldehyde (0.54 g, 3.60 mmol) were added with 30 mL of DCM to the one side (retentate) of the membrane. DCM (30 mL) was added to other side (permeate) of the membrane. To both the sides of the membrane, a small amount of butylhydroxytoluene (BHT) was added as an antioxidant. Solvent on both sides of the membrane was stirred continuously at room temperature. At 12, 24, 36, 48, 60, 84, and 108 hours, a 1 mL aliquot of solvent was removed from both sides of the membrane. Triphenylmethane (0.5 mL of a 0.25M stock solution) was added to each aliquot and the solvent was removed under vacuum. The aliquots were analyzed by ¹H NMR spectroscopy to determine the concentrations of FAMEs and p-nitrobenzaldehyde. Each separation was repeated three times. The same procedure was followed for all the membranes.

Separation of methyl stearate and methyl linolenate through HCOF(n)/epoxy, TpPA(n)/epoxy, TpBD(n)/epoxy, and TpBDDA COFs membranes in DCM as the solvent. A TpPA(20)/epoxy membranes were clamped between two glass vessels. Methyl stearate (1.07 g, 3.60 mmol), methyl linolenate (1.2 mL, 3.62 mmol) and p-nitrobenzaldehyde (0.54 g, 3.60 mmol) were added with 30 mL of DCM to the one side (retentate) of the membrane. DCM (30 mL) were added to other side (permeate) of the membrane. To both the sides of the membrane, a small amount of butylhydroxytoluene (BHT) was added as an antioxidant. Solvent on both sides of the membrane was stirred continuously at room temperature. At 12, 24, 36, 48, 60, 84, and 108 hours, a 1 mL aliquot of solvent was removed from both sides of the membrane. Triphenylmethane (0.5 mL of a 0.25M stock solution) was added to each aliquot and the solvent was removed under vacuum. The aliquots were analyzed by ¹H NMR spectroscopy to determine the concentrations of FAMEs and p-nitrobenzaldehyde. Each separation was repeated three times. The same procedure was followed for all the membranes.

Measurement of flux of FAs through COF/epoxy membranes. The flux of FAs was measured using the same method as described for the FAMEs but using a 75/25 CH₂Cl₂/MeOH solvent mixture.

Flux of FAMEs and FAs through S1(20)/epoxy membranes. The flux of FAMEs and FAs were investigated using S1(20)/epoxy membranes using the same method as previously described for measuring the flux of FAMEs.

Permeation of ethyl octanoate and methyl stearate through TpPa(20)/epoxy membrane. A TpPa (20)/epoxy membrane was placed between two glass reservoirs and DCM (30 mL) was added to the permeate and retentate sides of the membrane. Ethyl octanoate (0.72 mL, 3.60 mmol), methyl stearate (1.07 g, 3.60 mmol), and p-nitrobenzaldehyde (0.54 g, 3.60 mmol) were added to the retentate side. To both the sides of the membrane a small amount of BHT was added as an antioxidant. Solvent on both sides of the membrane was stirred continuously at room temperature. At 12, 24, 36, 48, 60, 84, and 108 hours, a 1 mL aliquot of solvent was removed from solvent on both sides of the membrane. The aliquots were used to determine the concentration and the absolute amounts of methyl stearate, ethyl octanoate, and p-nitrobenzaldehyde by ¹H NMR spectroscopy after the addition of triphenylmethane (0.5 mL of a 0.25 M solution) dissolved in DCM as an internal standard.

Permeation of methyl(Z)-5-octenoate with TpPa(20)/epoxy membranes. A TpPa (20)/epoxy membrane was placed between two glass reservoirs and DCM (30 mL) was added to the permeate and retentate sides of the membrane. Methyl (Z)-5-octenoate (0.6 mL, 3.60 mmol), methyl stearate (1.07 g, 3.60 mmol), and p-nitrobenzaldehyde (0.54 g, 3.60 mmol) were added to the retentate side. To both the sides, small amount of BHT was added as an antioxidant. Solvent on both sides of the membrane was stirred continuously at room temperature. At 12, 24, 36, 48, 60, 84 and 108 hours, a 1 mL aliquot of solvent was removed from solvent on both sides of the membrane. The aliquots were used to determine the concentration and the absolute amounts of the methyl stearate, methyl (Z)-5-octenoate, and p-nitrobenzaldehyde by ¹H NMR spectroscopy after the addition of triphenylmethane (0.5 mL of a 0.25 M solution) dissolved in DCM as an internal standard.

Purification of methyl linoleate from methyl stearate using multiple extractions. A TpPa(20)/epoxy membrane was placed between two glass reservoirs and DCM (30 mL) was added to the permeate and retentate sides of the membrane. Methyl linoleate (6.0 mL, 18.0 mmol), and methyl stearate (5.35 g, 18.0 mmol) were added to the retentate sides. To both sides of the membrane a small amount of BHT was added as an antioxidant. Solvent on both sides of the membrane was stirred continuously at room temperature. After 48 hours the solvent in the permeate side was removed and replaced with fresh 30 mL DCM. This process was repeated four more times. After the fifth extraction, the solvent in both sides of the membrane was removed and replaced with 30 mL of fresh DCM to extract any FAMEs retained in the membrane. The amounts of methyl stearate and methyl linoleate in each extraction was determined by ¹H NMR spectroscopy after the addition of triphenylmethane (0.5 mL of a 0.25 M solution) dissolved in DCM as an internal standard.

Flux of methyl stearate and methyl linolenate through TpPa(20)/epoxy membrane using different solvents. The flux of methyl stearate and methyl linolenate were investigated using the same procedure as described previously but using the solvents described in Table 4.

Fabrication of the TpPA COF thin membranes. A PZ flat sheet membrane with a molecular weight cutoff of 30,000 grams per mole was fixed on the bottom of a glass petri dish (D×H=150 mm×25 mm) using double-sided tape. Next, p-phenylenediamine (49.7 mg, 0.45 mmol) and p-toluene sulfonic acid (175.1 mg, 1.01 mmol) were dissolved in 20 mL DI water and poured into the glass petri dish. 2,4,6-Triformylphloroglucinol (63.2 mg, 0.3 mmol) was dissolved in 65 mL hexane and was slowly added onto the top surface of the aqueous layer. The petri dish was covered with aluminum foil kept in a stationary position. An orange thin film was observed at the interface between the two immiscible phases after 2 hours. After 24 hours, both the aqueous and organic solutions were removed and the thin film was rested on the top of the PZ membrane. The resulting COF thin membrane was thermally treated at 90° C. for 6 hours. Finally, the thin film was rinsed three times with DI water and acetone to wash away residual monomers and then dried at 90° C. for 2 hours. This membrane was labelled as TpPAM.

### Result and Discussion

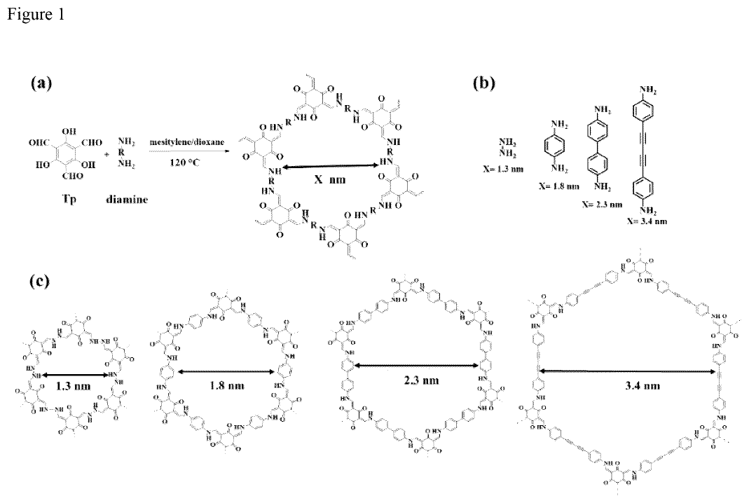

Synthesis and the characterization of COFs. Four COFs were synthesized by the reaction of diamines with Tp to yield imine-based COFs (FIGS. 1a and b). The COFs and their pore apertures were HCOF (1.3 nm), TpPA (1.8 nm), TpBD (2.4 nm), and TpBDDA (3.4 nm) as shown in FIG. 1c. The syntheses of these COFs were previously reported (Kandambeth, S., et al., Journal of the American Chemical Society 2012, 134 (48), 19524-19527; Lu, J., et al., New Journal of Chemistry 2019, 43 (16), 6116-6120; Biswal, B. P, et al., Journal of Materials Chemistry A 2015, 3 (47), 23664-23669; and Pachfule, P., et al., Journal of the American Chemical Society 2018, 140 (4), 1423-1427). Variations in the synthetic methods are reported herein.

The morphologies of the COFs were analyzed by scanning electron microscopy (SEM), PXRD, and IR spectroscopy and compared to prior work. SEM images showed that the COFs crystallized with nanometer-sized dimensions. The energy dispersive spectrum of the TpPA COF showed that the COF contained a mix of C, N, and O. The COFs were crystalline as shown by PXRD, and their spectra matched spectra from prior work and the corresponding simulated patterns. All of these spectra had a broad reflection at ˜25 degrees which was assigned to the (001) plane and confirmed the synthesis of 2D COFs in a crystalline and π-π stacked form. The other peaks and their assignments for HCOF were located at 6.2° (100) and 11.5° (210) (Lu, J., et al., New Journal of Chemistry 2019, 43 (16), 6116-6120). Similarly, for the TpBD COF the most intense peak was visible at 3.3° (100) with other minor peaks at 6.3° (200) and 11.7° (210) (Biswal, B. P, et al., Journal of Materials Chemistry A 2015, 3 (47), 23664-23669). Importantly, the PXRD spectra matched with the eclipsed (AA) stacking model, which indicated that the pores were aligned and formed a tunnel through the COFs (Biswal, B. P, et al., Journal of Materials Chemistry A 2015, 3 (47), 23664-23669). FT-IR spectra of the COFs showed bands associated with the C═O, C═C and C—N stretching modes which was consistent with previously reported work (Kandambeth, S., et al., Journal of the American Chemical Society 2012, 134 (48), 19524-19527; Daugherty, M. C., et al., Chemical Communications 2019, 55 (18), 2680-2683; Lu, J., et al., New Journal of Chemistry 2019, 43 (16), 6116-6120; and Pachfule, P., et al., Journal of the American Chemical Society 2018, 140 (4), 1423-1427).

Fabrication of COF/polyepoxy membranes. The COFs were incorporated into a polyepoxy matrix to synthesize COF(n)/epoxy mixed matrix membranes where n was the percent loading by weight of the COFs in the polyepoxy. To synthesize the membranes, the resorcinol diglycidyl ether and the amine were first thoroughly mixed and placed under slight vacuum to remove air bubbles. Next, either 10% or 20% by weight of a COF was added to the prepolymer and sonicated for 30 minutes to yield a suspension with the COFs well dispersed. Next, the COF/epoxy mixture was spin coated on a PZ membrane. The PZ membranes are a commercial poly(acrylonitrile) organic solvent nanofiltration membrane with a molecular weight cutoff of 30,000 g mol⁻¹. The PZ membranes were used to provide structural support to the mixed matric membranes, and prior work demonstrated that they did not separate C18 FAs or FAMEs (Gilmer, C. M., et al., ACS Applied Materials & Interfaces 2016, 8 (36), 24104-24111). Finally, the mixed matrix membranes were cured under a saturated atmosphere of DMF at 25° C. for 48 hours. Eight mixed matrix membranes were fabricated using 10 or 20% COF including: HCOF(10)/epoxy, HCOF(20)/epoxy, TpPA(10)/epoxy, TpPA(20)/epoxy, TpBD(10)/epoxy, TpBD(20)/epoxy, Tp-BDDA(10)/epoxy and TpBDDA(20)/epoxy. The top surface and cross-section of the TpPA(20)/epoxy membrane was characterized by SEM. The top surface of the membrane was flat and largely featureless; the cross-section of the membrane showed that the polyepoxy was in contact with the solid support and was approximately 90 microns thick.

The COF(n)/epoxy membranes were characterized by wide angle X-ray diffraction (WXRD). Polyepoxy membranes without COFs were fabricated on the PZ solid support to investigate peaks due to these materials. Polyepoxy membranes in the absence of COFs showed a broad WAXD peak from 12-30°, which was consistent with its amorphous nature (Kanimozhi, K., et al., High Performance Polymers 2015, 27 (7), 833-841) The COF(n)/epoxy membranes were analyzed by WAXD to ensure the crystalline structure of HCOF, TpPA, TpBD and TpBDDA COFs embedded inside the epoxy matrix. The WAXD patterns of the mixed matrix membranes all possessed a large, broad peak from 12-30° for the amorphous polyepoxy component and peaks that were present in the PXRD of the COFs before incorporation into the membrane. These results confirmed that the COFs were encapsulated within the polyepoxy matrix and that the COFs maintained their structures (Biswal, B. P., et al., Chemistry—A European Journal 2016, 22 (14), 4695-4699).

The structural integrity of the COFs in the polyepoxy were also confirmed via FT-IR spectroscopy. In prior work it was shown that the reaction of amines and epoxides to yield polyepoxy membranes was complete after 48 hours (Gilmer, C. M., et al., ACS Applied Materials & Interfaces 2016, 8 (36), 24104-24111). This result was confirmed by examining the FT-IR spectrum of a polyepoxy membrane fabricated without COF. The epoxide peaks at approximately 860 and 910 cm⁻¹ were completely missing after 48 hours, which confirmed that the epoxides were reacted. In addition, the disappearance of the N—H peaks around 3375 and 3310 cm⁻¹ and appearance of a broad peak for the OH at 3500 cm⁻¹ provided further evidence that reactions between the amines and epoxides were completed (Gilmer, C. M., et al., ACS Applied Materials & Interfaces 2016, 8(36), 24104-24111). In the mixed matrix membranes, the appearance of peaks at approximately 1550 cm⁻¹ were due to the C═C bond of the reacted Tp, the peaks at 1480 and 1265 cm⁻¹ were due to the C═C (Ar) and C—N functional groups (Kandambeth, S., et al., Journal of the American Chemical Society 2012, 134 (48), 19524-19527). Further, the average thickness of the COF(n)/epoxy membranes were approximately 55±10 μm.

Separation of C18 FAMEs using COF(n)/epoxy membranes. The separation of C18 FAMEs by osmosis was completed as shown in FIG. 2. A COF(n)/epoxy membrane was placed vertical between two solvent reservoirs. On the retentate side of the membrane the FAMEs were added in a solvent, and solvent was added to the permeate side of the membrane. Solvents on both sides of the membrane were well mixed throughout the separation using stir bars. In addition to the FAMEs, p-nitrobenzaldehyde was used as an internal standard in each experiment and a small amount of butylhydroxytoluene (BHT) was added as an antioxidant to the retentate and permeate sides. At periodic times an aliquot was removed from the retentate and permeate, the solvent was evaporated, and the composition of the FAMEs was measured by NMR spectroscopy. The absolute flux of C18 FAMEs for each membrane was determined using a mathematical model as reported in literature (Gilmer, C. M., et al., ACS Applied Materials & Interfaces 2016, 8 (36), 24104-24111). The separation of the four most important vegetable oil FAMEs were investigated: methyl stearate (C18:0), methyl oleate (C18:1), methyl linoleate (C18:2), and methyl linolenate (C18:3).

The flux of the FAMEs was measured in triplicate for each of the eight mixed matrix membranes. In Table 1 the absolute flux for each FAME is shown, and for each membrane the flux of methyl linolenate was set equal to one and the relative flux for the other FAMEs were listed. Several observations emerged including that for each membrane the higher the degree of unsaturation the slower the flux; methyl stearate had the most rapid flux and methyl linolenate had the slowest flux. The fluxes of the FAMEs were faster when the COF(10)/epoxy membranes were used compared to the COF(20)/epoxy membranes. The largest difference in flux between methyl stearate and methyl linolenate was for the TpPA(20)/epoxy membrane. This membrane had pore sizes of 1.8 nm, and the difference in flux was lower when the pore size of the COF was smaller or larger than this value.

TABLE 1
Absolute and relative fluxes of C18 FAMEs through different COF(n)/epoxy membranes.

| | Absolute flux {10⁻⁷} (mol/h cm²) | | | | Flux of chemicals relative to methyl linolenate | | | |
|---|---|---|---|---|---|---|---|---|
| COF(n)/epoxy | | | Methyl | Methyl | Methyl | Methyl | Methyl | Methyl |
| membranes | Methyl Stearate | Methyl Oleate | Linoleate | Linolenate | Stearate | Oleate | Linoleate | Linolenate |
| HCOF(20)/epoxy | 10.4 ± 1.18 | 5.7 ± 1.32 | 4.7 ± 0.67 | 2.2 ± 1.58 | 4.7 | 2.5 | 2.1 | 1 |
| TpPA(20)/epoxy | 20.1 ± 0.04 | 10.1 ± 0.28 | 8.7 ± 1.29 | 3.4 ± 0.68 | 5.9 | 2.9 | 2.6 | 1 |
| TpBD(20)/epoxy | 21.3 ± 1.12 | 11.4 ± 1.12 | 9.9 ± 0.67 | 4.8 ± 0.58 | 4.5 | 2.4 | 2.1 | 1 |
| TpBDDA(20)/epoxy | 22.7 ± 0.02 | 12.4 ± 0.06 | 11.2 ± 0.27 | 6.1 ± 0.03 | 3.8 | 2.0 | 1.8 | 1 |
| HCOF(10)/epoxy | 12.5 ± 0.34 | 8.2 ± 1.09 | 5.8 ± 0.85 | 3.9 ± 0.94 | 3.2 | 2.1 | 1.5 | 1 |
| TpPA(10)/epoxy | 23.5 ± 0.14 | 15.6 ± 1.09 | 10.9 ± 0.52 | 6.2 ± 0.44 | 3.8 | 2.5 | 1.8 | 1 |
| TpBD(10)/epoxy | 25.1 ± 0.23 | 19.7 ± 1.03 | 15.1 ± 1.01 | 9.3 ± 1.05 | 2.7 | 2.1 | 1.6 | 1 |
| TpBDDA(10)/epoxy | 28.2 ± 0.63 | 23.6 ± 0.77 | 19.2 ± 1.01 | 12.4 ± 1.01 | 2.3 | 1.9 | 1.5 | 1 |
| Epoxy membrane | 32.6 ± 0.76 | 29.4 ± 0.87 | 26.8 ± 0.62 | 25.6 ± 0.89 | 1.2 | 1.2 | 1.1 | 1 |
| (Without a COF) | | | | | | | | |
| S1(20)/epoxy | 30.2 ± 0.43 | 28.4 ± 0.71 | 27.5 ± 0.47 | 24.7 ± 0.53 | 1.2 | 1.1 | 1.1 | 1 |

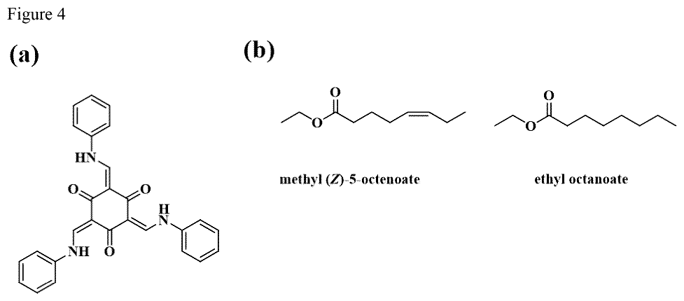

Two control experiments were completed to investigate the effect of the polyepoxy matrix and the COFs in the separations. Polyepoxy membranes were fabricated without a COF and the separation of the FAMEs were investigated (Table 1). The fluxes of the FAMEs were similar for this membrane which provided further proof that the COFs were necessary for the separations. To investigate if noncovalent interactions between the FAMEs and the COFs were responsible for the difference in flux of the FAMEs, a fragment of a COF was synthesized and labelled S1 (FIG. 4). This fragment was incorporated into a polyepoxy membrane and the separation of the FAMEs were investigated (Table 1). The FAMEs had very similar flux through the S1(20)/epoxy membrane and were nearly identical to the small differences in flux found with membranes fabricated only from polyepoxy. This experiment demonstrated that the pores in the COFs, rather than the functional groups in the COFs, were responsible for the separation of FAMEs.

The ability to recycle the membranes was investigated using the TpPA(20)/epoxy membrane. The FAMEs were separated and then the membrane was washed thoroughly in CH₂Cl₂. Next, a new set of FAMEs were separated, and then the membrane was washed in CH₂Cl₂ before a third separation of FAMEs was separated. The flux and separation of the FAMEs decreased with each cycle.

Separation of C18 FAs using COF(n)/epoxy membranes. Mixtures of FAs were separated using three COF(20)/epoxy membranes using the same method as described for the separation of the FAMEs except for the choice of solvents (Table 2). All the FAMEs were soluble in DCM, so this solvent was used for those separations, but stearic acid was not soluble in DCM. To separate the FAs, a 75%/25% DCM/MeOH solvent mixture was used.

The results in Table 2 showed that the general trends for the separation of FAs were similar to those obtained for the separations of FAMEs. For each membrane the flux decreased as the degree of unsaturation increased, and the mixed matrix membrane fabricated with TpPA (pore size=1.8 nm) had the largest difference in flux between linolenic acid and stearic acid. When the pore size was smaller or larger than 1.8 nm, the differences in flux decreased.

In control experiments, the separation of FAs through polyepoxy membranes and S1(20)/epoxy membranes showed little difference in flux (Table 2). These experiments provided further evidence that the pores of COFs were responsible for the separation of the FAs.

TABLE 2
Absolute and relative fluxes of C18 FAs through different COF(n)/epoxy membranes.

| | Absolute flux {10⁻⁷} (mol/h cm²) | | | | Flux of chemicals relative to linolenic acid | | | |
|---|---|---|---|---|---|---|---|---|
| COF(n)/epoxy | Stearic | Oleic | Linoleic | Linolenic | Stearic | Oleic | Linoleic | Linolenic |
| membranes | acid | acid | acid | acid | acid | acid | acid | acid |
| HCOF(20)/epoxy | 6.7 ± 1.23 | 3.7 ± 1.1 | 2.4 ± 1.21 | 1.8 ± 1.18 | 3.7 | 2.0 | 1.3 | 1 |
| TpPA(20)/epoxy | 13.9 ± 1.3 | 6.6 ± 1.01 | 4.3 ± 1.09 | 3.1 ± 0.69 | 4.5 | 2.2 | 1.4 | 1 |
| TpBD(20)/epoxy | 15.1 ± 1.02 | 11.3 ± 0.58 | 6.4 ± 0.52 | 5.2 ± 0.29 | 2.9 | 2.1 | 1.2 | 1 |
| S1(20)/epoxy | 15.6 | 13.7 | 12.2 | 12.0 | 1.3 | 1.2 | 1.0 | 1 |
| Epoxy membrane | 16.2 | 15.0 | 14.8 | 12.3 | 1.3 | 1.2 | 1.2 | 1 |

Permeation of methyl (Z)-5-octenoate and ethyl octanoate through TpPa(20)/epoxy membrane. The permeation of methyl (Z)-5-octenoate (C8:3) and ethyl octanoate (C8:0) were investigated to determine if differences in molecular weights affected flux of fatty acid esters. Methyl (Z)-5-octenoate has one cis-pi bond similar to methyl oleate but its molecular weight is 156.2 g mol⁻¹ and methyl oleate has a molecular weight of 310.5 g mol⁻¹. The flux of methyl (Z)-5-octenoate was 2.5× faster than the flux of methyl oleate through a TpPA(20)/epoxy membrane. Similarly, the flux of ethyl octanoate (molecular weight: 172.2 g mol⁻¹) was 1.8× faster than the flux of methyl stearate (molecular weight: 298.5 g mol⁻¹). Both experiments showed that the flux of fatty acid esters had a small dependence on molecular weights.

Origin of difference in flux for FAMEs and FAs. The difference in flux was consistent for all membranes and showed that as the degree of unsaturation increased the flux was slower for both FAs and FAMEs. The rate of diffusion of chemicals within a membrane correlates with their flux, and these rates are highly dependent on the size of chemicals and interactions of the chemicals with the membrane (Gilmer, C. M., et al., RSC advances 2017, 7(88), 55626-55632; Gilmer, C. M., et al., ACS Applied Materials & Interfaces 2016, 8 (36), 24104-24111; Long, T. R., et al., Journal of Materials Chemistry 2011, 21 (37), 14265-14276; and Liu, Z., et al., Journal of Hazardous Materials 2018, 355, 145-153). Larger chemicals tend to have slower flux than smaller chemicals, and chemicals that interact strongly with the membranes also have slow flux (Gilmer, C. M., et al., ACS Applied Materials & Interfaces 2016, 8 (36), 24104-24111; and Liu, Z., et al., Journal of Hazardous Materials 2018, 355, 145-153). Furthermore, pore sizes of the membranes must be similar in size to the chemicals for effective separations. The separation of FAMEs is challenging because they have numerous different conformations with similar energies, so their sizes and shapes are rapidly changing. Because of these fluxional sizes and shapes, four different membranes were investigated that had different pore sizes on the size scale of the FAMEs.

Experiments that investigated the flux of FAs and FAMEs through membranes fabricated with the COF fragment S1 showed that the difference in flux was not due to interactions between the FAMEs and FAs. The COF fragment S1 contained the functional groups of the COFs, but it had no effect on the separation of the FAMEs and FAs. The difference in flux was likely due to slight differences in the conformations and sizes of the chemicals. It is noteworthy that the FAMEs and FAs had a <2.2% difference in molecular weight and highly fluxional structures that made determining their sizes challenging.

In prior work by others, the radii of gyration, end to end distances, and characteristic ratios were investigated in silico for selected FAMEs (Table 3) (Bharadwaj, V. S., et al., ChemPhysChem 2015, 16 (13), 2810-2817). The end-to-end distance was defined as the average of the separation between the two ends of the FAMEs and the characteristic ratio was a measure of the flexibility of the FAMEs. The larger the value for the characteristic ratio, the longer the average extended chain was for a FAME. The unsaturated FAMEs possessed lower values for the characteristic ratios than the saturated FAME which indicated that they possessed more compact structures as expected based on the cis-pi bonds that add curvature to FAMEs. It is important to note that the TpPA/epoxy membranes had pore sizes of 1.8 nm for the COFs which was similar to the end-to-end distances of the FAMEs reported in Table 3. Membranes fabricated from HCOF (pore size: 1.3 nm) had pore sizes that were smaller than the FAMEs, and those fabricated from TpBD (pore size: 2.3 nm) and TpBDDA (pore size 3.4 nm) had pore sizes larger than the FAMEs and provided less ability to separate them. The TtPA COFs had pore sizes that were best optimized to separate the FAMEs (Zhang, J.-L, et al., Industrial Crops and Products 2015, 63, 1-8).

TABLE 3
Radii of gyration, end to end distances, and characteristic
ratios for FAMEs at 333 K was reported in the literature.¹³

| | radii of | end to end | characteristic |
|---|---|---|---|
| | gyration | distances | ratios |
| Type of FAMEs | (Å) | (Å) | (unitless) |
| Methyl stearate (C18:0) | 6.9 ± 0.6 | 20.8 ± 3.1 | 9.4 ± 0.3 |
| Methyl oleate (C18:1) | 5.4 ± 0.6 | 14.9 ± 4.0 | 5.2 ± 0.5 |
| Methyl linoleate (C18:2) | 5.4 ± 0.7 | 14.2 ± 3.8 | 4.8 ± 0.5 |
| Methyl linolenate (C18:3) | 5.3 ± 0.5 | 13.4 ± 0.5 | 4.4 ± 0.5 |

An aspect that further complicates the analysis is that the FAMEs and FAs were dissolved in CH₂Cl₂ (for FAMEs) and 75%/25% CH₂Cl₂/CH₃OH (for FAs) at loadings of 2 grams of FAME or FAs per 60 mL of solvent. When the solvent was changed, the difference in flux for methyl stearate and methyl linolenate changed substantially for the TpPA(20)/epoxy as shown in Table 4. Although the trend of faster flux for methyl stearate than methyl linolenate held for each solvent, there was a significant difference in the ratio for different solvents. The change in solvent affects how the FAMEs, FAs, and COFs are solvated, and it affects their structures such as their radii of gyration (Li, Y., et al., Comptes Rendus Chimie 2014, 17 (3), 242-251; Liong, K. K., et al., Industrial & engineering chemistry research 1992, 31 (1), 390-399; Oliveira, C. J., et al., Colloids and Surfaces A: Physicochemical and Engineering Aspects 2020, 585, 124086; and Song, Y., et al., Physical Chemistry Chemical Physics 2019, 21 (48), 26591-26597). In addition, the change in solvent can affect whether FAMEs flux primarily through the polyepoxy (with little difference in flux for FAMEs) or the COFs. The difference in ratio of flux for the different solvents in Table 4 did not correlate with the dielectric constant or dipole moments of solvents. Due to these challenges, a full understanding of the molecular basis for the difference in flux was not determined.

TABLE 4
The relative flux of methyl stearate relative to methyl linolenate
with different solvents (Smallwood, I.
Handbook of Organic Solvent Properties; Butterworth-Heinemann, 2012)

Solvent

| Item | CH₂Cl₂ | CHCl₃ | CH₃OH | Acetone |
|---|---|---|---|---|
| Ratio for flux of | 5.9 | 3.8 | 2.7 | 1.8 |
| methyl stearate and | | | | |
| methyl linolenate | | | | |
| Dielectric constant | 8.93 | 4.81 | 32.7 | 20.7 |
| Dipole moment | 1.14 | 1.15 | 2.87 | 2.69 |

Multiple extractions to purify a FAME from a mixture FAMEs. The ability of the membranes to separate and purify methyl linoleate was investigated using multiple separations. An equimolar mixture of methyl stearate and methyl linoleate (5.35 g of each) were added to the retentate side of a membrane separation as before, and after a period of time the solvent and FAMEs on the permeate side were removed and replaced with fresh solvent. The composition of the retentate had increasing higher ratios of methyl linoleate to methyl stearate due to the slower flux of methyl linoleate. The purity of methyl linoleate was 50% in the initial mixture and 77% after the fourth cycle and 85% after the fifth cycle. The permeate samples were combined and they had a final composition of 33% methyl linoleate and 67% methyl linoleate. Over 98% of the FAMEs that were added were found in either the retentate or permeate which demonstrated that only a small amount was found in the membrane or otherwise lost. These experiments demonstrated the potential of these membranes to separate and purify FAMEs.

TABLE 5
Composition of C18 FAMEs in the retentate
side of the membrane after each cycle.

| | Amount of FAME in Retentate | | | | | |
|---|---|---|---|---|---|---|
| | Initial | | | | | |
| | amount | Cycle 1 | Cycle2 | Cycle 3 | Cycle 4 | Cycle 5 |
| Chemical | (mmol) | (mmol) | (mmol) | (mmol) | (mmol) | (mmol) |
| Methyl stearate | 18.0 | 10.12 | 8.25 | 6.12 | 3.21 | 1.71 |
| Methyl linoleate | 18.0 | 14.34 | 13.14 | 12.08 | 10.84 | 9.86 |
| Purity of methyl | 50% | 59% | 61% | 66% | 77% | 85% |
| linoleate | | | | | | |
| Methyl stearate | 18.0 | 10.12 | 8.25 | 6.12 | 3.21 | 1.71 |
| Methyl linoleate | 18.0 | 14.34 | 13.14 | 12.08 | 10.84 | 9.86 |
| Purity of methyl | 50% | 59% | 61% | 66% | 77% | 85% |
| linoleate | | | | | | |

Permeation of fatty acid esters through TpPAM using dead end filtration. A TpPAM membrane (area was approximately 0.044 m²) was placed in a metal dead-end filtration apparatus. The methyl esters from linseed oil (50 mL) were dissolved in dichloromethane (50 mL) and added to the pressure apparatus. A small amount of butylhydroxytoluene was added as an antioxidant. The apparatus was pressurized to 50 psi and the permeate was collected at different time internals. A typical time interval was 15 minutes. When the experiment was completed, the apparatus was depressurized and the retentate was collected. All samples were analyzed by ¹H NMR spectroscopy to determine the composition of the permeate and the retentate fractions.

The initial composition of the fatty acid esters was approximately 53.1% methyl linolenate and the remainder were the other fatty acid esters (Table 6). The first three permeate samples were enriched in the other fatty acid esters and had lower concentrations of methyl linolenate. The retentate that remained at the end had a composition of 80.5% methyl linolenate which was

| | | Methyl | |
|---|---|---|---|
| | Mass of FAMEs | linolenate (Ω−3) | All other FAMES |
| | (g) | (mol %) | (mol %) |
| Initial | 44.19 ± 1.1 | 53.1 ± 0.05 | 46.1 ± 0.05 |
| composition | | | |
| Permeate 1 | 10.12 ± 1.42 | 45 ± 2.14 | 55 ± 2.14 |
| Permeate 2 | 9.27 ± 1.26 | 46.5 ± 1.55 | 53.5 ± 1.55 |
| Permeate 3 | 8.19 ± 1.57 | 50.5 ± 2.98 | 49.5 ± 2.98 |
| Permeate 4 | 8.21 ± 2.13 | 55 ± 3.41 | 45 ± 3.41 |
| Final retentate | 5.43 ± 1.05 | 80.5 ± 4.58 | 19.5 ± 4.58 |

enriched from the starting mixture.

Table 6. The separation of fatty acid esters from linseed oil using a pressure separation is shown.

### CONCLUSIONS

Industrial methods to inexpensively separate mixtures of C18 FAs and FAMEs are based on technology that is over four decades old; new methods are needed to produce streams highly enriched in one FA or FAME. Membrane separations offer a solution to this challenge, but C18 FAMEs and FAs have very similar sizes and shapes and prior polymeric membranes were ineffective at separating them. Mixed matrix membranes composed of nanometer-sized COFs embedded within polyepoxy have been found to effectively separate C18 FAMEs and FAs based on their degrees of unsaturation. One difference between these membranes and polymeric membranes is that polymeric membranes have broad distributions of pore sizes, while the crystalline structures of the COFs have narrow, nanometer-sized, and well-defined pores that provide selective separation. The COF with a pore size of about 1.8 nm had the largest difference in flux; COFs with smaller or larger pore sizes were less effective at separating the FAMEs and FAs.

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

What is claimed is:

1. A method comprising:
providing a starting liquid that comprises two or more compounds selected from the group consisting of fatty acids and fatty acid esters, wherein each compound is present in a starting mole ratio with respect to each other compound;
passing the liquid through a membrane that comprises covalent organic frameworks to provide a filtered liquid; and
collecting a fraction of the filtered liquid wherein at least one mole ratio between two compounds has changed from the corresponding mole ratio in the starting liquid.

2. A method for increasing the purity of a fatty acid or a fatty acid ester, from a starting liquid that comprises the fatty acid or the fatty acid ester and at least one other fatty acid or at least one other fatty acid ester, comprising: passing the starting liquid through a membrane that comprises covalent organic frameworks under conditions that allow the fatty acid or the fatty acid ester and the at least one other fatty acid or the at least one other fatty acid ester to pass through the membrane at different rates, so that the purity of the fatty acid or the fatty acid ester is increased on one side of the membrane.

3. The method of claim 2, further comprising collecting the fatty acid or the fatty acid ester of increased purity.

4. The method of claim 1, wherein the starting liquid comprises two or more fatty acids.

5. The method of claim 1, wherein the starting liquid comprises two or more fatty acid esters.

6. The method of claim 1, wherein the starting liquid is at its boiling point.

7. The method of claim 1, wherein the starting liquid is at a temperature in the range of about 25° C. to about 50° C.

8. The method of claim 1, wherein the starting liquid comprises a solvent selected form the group consisting of (C₁-C₄)alkanols, hexanes, or methylene chloride.

9. The method of claim 1, wherein the starting liquid comprises a fish oil, a seed oil, corn oil, soybean oil, palm oil, or linseed oil.

10. The method of claim 1, wherein the membrane comprises covalent organic frameworks and at least one polymer selected from the group consisting of, epoxy, polyimides, polyamides, polyether ether ketone, polyesters, polybutadiene, polyisoprene, and random or block polymers.

11. The method of claim 10, wherein the covalent organic frameworks represent about 5% to about 20% of the membrane by weight.

12. The method of claim 1, wherein the covalent organic frameworks are boroxine-linked, boronate ester-linked, imine-linked, hydrazone-linked, azine-linked, β-ketoenamine-linked, triazine-linked, imide-linked, phenazine-linked, or sp²-carbon linked.

13. The method of claim 1, wherein the covalent organic frameworks are a β-ketoenamine-linked covalent organic framework.

14. The method of claim 1, wherein the covalent organic frameworks have average pore sizes in the range of from about 1 nanometer to 10 nanometers.

15. The method of claim 1, wherein the covalent organic frameworks have average pore sizes in the range of from about 2 nanometers to about 4 nanometers

16. The method of claim 1, wherein the membrane has a flux of at least 0.05 liters/meter² hour.

17. The method of claim 1, wherein three or more fractions are collected.

18. The method of claim 1, wherein the membrane that comprises covalent organic frameworks is coated onto a nanofiltration membrane backing.

19. The method of claim 18, wherein the backing comprises polydicyclopentadiene, polyimide, polyaniline, polyacrylate, or poly(acrylonitrile).

20. The method of claim 1, wherein the membrane is part of a spiral wound module.
